(19) United States
(12) Patent Application Publication
(10) Pub. No.: US 2010/0048395 A1
(43) Pub. Date: Feb. 25, 2010

(54) THERMOSENSITIVE RECORDING MATERIAL

(75) Inventor: Kunihiko OHGA, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/541,184

(22) Filed: Aug. 14, 2009

(30) Foreign Application Priority Data
Aug. 20, 2008 (JP) 2008-211831

(51) Int. Cl. B41M 5/28; B41M 5/323; B41M 5/333; B41M 5/327

(52) U.S. Cl. 503/216; 503/226; 503/221; 503/218

(57) ABSTRACT

The invention provides a thermosensitive recording material having, on a support, a thermosensitive recording layer incuding an electron-donating dye precursor and an electron-accepting compound that makes the electron-donating dye precursor thermally develop a color, wherein the thermosensitive recording layer includes the electron-accepting compound in a ratio of from 5/1 to 20/1 by mass ratio with respect to the electron-donating dye precursor.

### CROSS-REFERENCE TO RELATED APPILCATION

This application claims priority under 35 USC 119 from Japanese Patent Application NO. 2008-211831 filed on Aug. 20, 2008, the disclosure of which is incorporated by reference herein.

### BACKGROUND OF THE INVENTION

1. Field of the Invention

The present invention relates to a thermosensitive recording material.

2. Description of the Related Art

A thermosensitive recording method is advantageous in that (1) development is unnecessary, (2) when the support is a paper, its paper quality is similar to that of common paper, (3) handling is easy, (4) color density is high, (5) a recording apparatus is simple and inexpensive, and (6) there is no noise at the time of recording. Accordingly, use of thermosensitive recording is wide-spreading in fields such as facsimile and printer and label such as POS.

Under these circumstances, transparent thermosensitive recording materials capable of direct recording with a thermal head for coping with multiple colors or for projection of an image with an overhead projector (OHP), or for observing an image directly on a light table, have also been developed in recent years. There is increasing demand for image qualities with these thermosensitive recording materials.

As the sensitivity of the thermosensitive recording material is increased to cope with high-speed recording, an initial rise in color forming tends to be steep in response to printing energy. As a result, image gradation has been sacrificed.

To satisfy both sensitivity and image gradation, a thermosensitive recording material having, on a support, a second color-forming layer and a first color-forming layer coated thereon having the same color-forming tone, wherein the first color-forming layer forms color at lower temperatures than the second color-forming layer, has been discloded (see, for example, Japanese Patent Application Publication (JP-B) No. 6-30953). In this thermosensitive recording material, the color-forming of the first color-forming layer is prioritized in printing at low temperatures, while the color-forming of the second color-forming layer is utilized in printing at high temperatures.

A thermosensitive recording material excellent in gradation reproduction, provided with a thermosensitive recording layer containing an electron-donating dye precursor-encapsulated microcapsule and an electron-accepting compound, has been proposed (see, for example, Japanese Patent Application Laid-Open (JP-A) No. 2004-216878).

It has also been proposed that a hollow particle-containing undercoat layer is arranged on a support to attain higher sensitivity of a thermosensitive recording material (see, for example, JP-A No. 5-573).

The thermosensitive recording materials described in JP-B No. 6-30953 or JP-A No. 2004-216878 have a problem of failure to achieve sufficient sensitivity and image density. The thermosensitive recording material described in JP-A No. 5-573 fails to achieve sufficient gradation reproduction.

### SUMMARY OF THE INVENTION

The present invention has been made in view of the above circumstances and provides a thermosensitive recording material.

An aspect of the present invention provides a thermosensitive recording material comprising, on a support, a thermosensitive recording layer comprising an electron-donating dye precursor and an electron-accepting compound that makes the electron-donating dye precursor thermally develop a color, wherein the thermosensitive recording layer comprises the electron-accepting compound in a ratio of from 5/1 to 20/1 by mass ratio with respect to the electron-donating dye precursor.

### BRIEF DESCRIPTION OF THE DRAWINGS

FIG. 1 is a drawing that shows the relationship between the applied thermal energy and color density in Example 2 and Comparative Example 2.

### DETAILED DESCRIPTION OF THE INVENTION

The thermosensitive recording material of the present invention includes, on a support, a thermosensitive recording layer including an electron-donating dye precursor and an electron-accepting compound that makes the electron-donating dye precursor thermally develop a color (hereinafter also referred to as a “developer”), wherein the thermosensitive recording layer includes the electron-accepting compound in a ratio of from 5/1 to 20/1 by mass ratio with respect to the electron-donating dye precursor.

Since the thermosensitive recording material of the invention includes the electron-accepting compound in an amount of 5 times to 20 times (based on mass) the amount of the electron-donating dye precursor in the thermosensitive recording layer, the thermosensitive recording material develops a color even if the applied thermal energy is small (sensitivity is increased). Furthermore, it is deduced that, since the electron-accepting compound is used in an amount that is larger than the amount of the electron-donating dye precursor, the thermal energy required to develop a color down to the lower layer portion of the thermosensitive recording layer is increased, and the rate of change in color-forming concentration relative to the applied thermal energy is decreased, whereby color forming characteristics of a soft image gradation are exhibited. Namely, a highly sensitive thermosensitive recording material having an excellent soft image gradation may be obtained.

[Thermosensitive Recording Layer]

The thermosensitive recording layer in the invention includes at least one electron-donating dye precursor, and at least one electron-accepting compound that makes the electron-donating dye precursor thermally develop a color.

If necessary, the thermosensitive recording layer may further include an adhesive, an image stabilizer (an ultraviolet absorber or the like), and other components.

In the invention, a compound or composition that changes at least the spectral absorbance in the visible area where thermal energy is applied is referred to as a thermosensitive coloring component, which encompasses the above-mentioned electron-donating dye precursor and electron-accepting compound that makes the electron-donating dye precursor thermally develop a color.

As the electron-donating dye precursor and the electron-accepting compound, a known combination of an electron-donating dye precursor and an electron-accepting compound reacting with the electron-donating dye precursor thereby developing a color can be used without particular limitation.

From the viewpoints of sensitivity and color forming property, the thermosensitive color-forming component in the invention is preferably a composition containing at least one electron-donating dye precursor and at least one electron-accepting compound which reacts with the electron-donating dye precursor thereby developing a color.

—Electron-Donating Dye Precursor—

The thermosensitive recording layer in the invention preferably contains at least one electron-donating dye precursor. The electron-donating dye precursor can be suitably selected from those known in the art. Examples of the electron-donating dye precursor preferably include phthalide compounds such as triphenylmethane phthalide and indolyl phthalide, fluoran compounds, phenothiazine compounds, leucoauramine compounds, rhodamine lactam compounds, triarylmethane compounds, triazene compounds, spirodipyran compounds, pyridine compounds, pyrazine compounds and fluorene compounds. The fluorin- or phthalide-based electron-donating dye precursors are particularly preferable.

Examples of the phthalide compounds include those described in, for example, U.S. Pat. (USP) No. 23024 (reissued), U.S. Pat. No. 3,491,111, U.S. Pat. No. 3,491,112, U.S. Pat. No. 3,491,116 and U.S. Pat. No. 3,509,174.

Examples of the fluoran compounds include those described in, for example, U.S. Pat. No. 3,624,107, U.S. Pat. No. 3,627,787, U.S. Pat. No. 3,641,011, U.S. Pat. No. 3,462,828, U.S. Pat. No. 3,681,390, U.S. Pat. No. 3,920,510 and U.S. Pat. No. 3,959,571.

Examples of the spirodipyran compounds include those described in, for example, U.S. Pat. No. 3,971,808.

Examples of the pyridine compounds and pyrazine compounds include those described in, for example, U.S. Pat. No. 3,775,424, U.S. Pat. No. 3,853,869 and U.S. Pat. No. 4,246,318.

Examples of the fluorene compounds include those described in, for example, in JP-A No. 63-94878.

Specific examples of the electron-donating dye precursor include
2-anilino-3 -methyl-6-diethylaminofluoran,
2-anilino-3 -methyl-6-dibutylaminofluoran,
2-anilino-3 -methyl-6-(N-ethyl-N-isoamylamino)fluoran,
2-anilino-3 -methyl-6-(N-ethyl-N-propylamino)fluoran,
2-anilino-3 -methyl-6-di-n-amylaminofluoran,
2-anilino-3 -methyl-6-(N-ethyl-N-p-tolylamino)fluoran,
2-anilino-3 -methyl-6-N-ethyl-N-sec-butylaminofluoran,
3-N,N-dibutylamino-6-methyl-7-anilinofluoran,
6′-{ethyl(3-methylbutyl)amino}-3′-methyl-2′-(phenylamino)-fluoran,
3-(N-n-hexyl-N-ethylamino)-6-methyl-7-anilinofluoran,
3-[N-(3-ethoxypropyl)-N-ethylamino]-6-methyl-7-anilinofluoran,
3-di(n-butylamino)-7-(2-chloroanilino)fluoran,
3-diethylamino-7-(2-chloroanilino)fluoran,
3-(N-cyclohexyl-N-methylamino)-6-methyl-7-anilinofluoran,
2-anilino-3-methyl-6-(N-isobutyl-N-methylamino)fluoran,
2-anilino-3 -methyl-6-(N-n-amyl-N-methylamino)fluoran,
2-anilino-3-methyl-6-(N-n-amyl-N-ethylamino)fluoran,
2-anilino-3-methyl-6-(N-n-propyl-N-isopropylamino)fluoran,
2-anilino-3-methyl-6-(N-methyl-N-p-toluidino)fluoran,
3-diethylamino-7,8-benzofluoran, 1,3-dimethyl-6-diethylaminofluoran,
1,3-dimethyl-6-di-n-butylaminofluoran, 3-diethylamino-7-methylfluoran,
3-diethylamino-7-chlorofluoran, 3-diethylamino-6-methyl-7-chlorofluoran,
10-diethylamino-2-ethylbenzo[1,4]thiadino[3,2-b]fluoran,
3,3-bis(1-n-butyl-2-methylindol-3-yl)phthalide,
3,3 -bis(4-diethylamino-2-ethoxyphenyl)-4-azaphthalide,
3-[2,2-bis(1-ethyl-2-methyl-3-indolyl)vinyl]-3-(4-diethylaminophenyl)phthalide, and 3-[1,1-bis(4-diethylaminophenyl)ethylen-2-yl)-6-dimethylaminophthalide.
   Among these compounds, it is particularly preferable to include at least one member selected from the group consisting of
2-anilino-3-methyl-6-diethylaminofluoran,
2-anilino-3-methyl-6-dibutylaminofluoran,
2-anilino-3-methyl-6-(N-ethyl-N-isoamylamino)fluoran,
2-anilino-3-methyl-6-(N-ethyl-N-propylamino)fluoran,
2-anilino-3-methyl-6-di-n-amylaminofluoran,
3-N,N-dibutylamino-6-methyl-7-anilinofluoran,
6′-{ethyl(3-methylbutyl)amino}-3′-methyl-2′-(phenylamino)-fluoran,
2-anilino-3-methyl-6-N-ethyl-N-sec-butylaminofluoran, and
2-anilino-3-methyl-6-(N-ethyl-N-p-tolylamino)fluoran. These electron-donating dye precursors may be used alone or in a combination of two or more of them in a single thermosensitive recording layer.

When at least one of compounds selected from the above group is contained as the electron-donating dye precursor, background fog can be kept low and color density can be increased. And further image storage characteristics of an image part formed can be improved.

When a coating solution for forming the thermosensitive recording layer (hereinafter referred to sometimes as “coating solution for thermosensitive recording layer”) is prepared, the particle size of the electron-donating dye precursor is preferably 2.0 μm or less, more preferably from 0.5 μm to 1.2 μm, in terms of volume-average particle diameter. A volume-average particle diameter of 2.0 μm or less is preferable because of high thermosensitivity. A volume-average particle diameter of 0.5 μm or more is preferable for less background fog. The volume-average particle diameter can be easily measured by a laser diffraction particle size distribution measuring instrument (for example, LA500 manufactured by Horiba, Ltd.) etc.

Furthermore, in the invention, the above-mentioned electron-donating dye precursor may be used in the form of microcapsules enclosing the dye precursor, from the viewpoints of raw stock storability (prevention of fogging) of the thermosensitive recording layer such as prevention of contact with the electron-accepting compound at ordinary temperature, control of the color forming sensitivity so as to develop a color at a desired thermal energy, and the like.

The microcapsules usable in the invention can be produced by any methods of interfacial polymerization, internal polymerization and external polymerization. It is particularly preferable to use an interfacial polymerization method wherein a core substance containing the electron-donating dye precursor is emulsified in an aqueous solution having a water-soluble polymer dissolved therein, and then a wall of the polymer material is formed around its oil droplets. A reactant forming the polymer material is added to the inside of oil droplets and/or the outside of oil droplets.

Specific examples of the polymer material include polyurethane, polyurea, polyamide, polyester, polycarbonate, urea-formaldehyde resin, melamine resin, polystyrene, a styrene/methacrylate copolymer and a styrene/acrylate copolymer. The polymer material is preferably polyurethane, polyurea, polyamide, polyester or polycarbonate, more preferably polyurethane or polyurea. That is, the microcapsule preferably has a polymer film wall having urethane or urea bonds. The polymer materials can also be used in a combination of two or more of them.

Specific examples of the above-mentioned water-soluble polymer may include gelatin, polyvinyl pyrrolidone, polyvinyl alcohol and the like. Specifics of the method for producing a microcapsule conjugated wall are described in, for example, JP-A No.58-66948. When the electron-donating dye precursor is enclosed in microcapsules, it is preferable that the electron-donating dye precursor is used as a solution in an organic solvent.

Such organic solvent includes low-boiling solvents such as ethyl acetate, methyl acetate, carbon tetrachloride, chloroform, methanol, ethanol, n-butanol, dioxane, acetone and benzene, and high-boiling solvents such as phosphates, carboxylates such as phthalate, fatty acid amides, alkylated biphenyl, alkylated terphenyl, chlorinated paraffin, alkylnaphthalene and diarylethane. Such organic solvents are described in detail in JP-A No. 4-19778. Microcapsules substantially not containing an organic solvent as shown in JP-A No. 4-101885 can also be used.

If necessary, a metal-containing dye, a charge regulator such as nigrosine, and other additives can be added to the microcapsule wall used in the invention. These additives can be added at any time point before or during formation of the wall. For regulating charging of the surface of the microcapsule wall, vinyl monomers or the like may be added and graft-polymerized.

A solid sensitizer for swelling the microcapsule wall during heating may further be added to the microcapsules encapsulating the electron-donating dye precursor. A solid sensitizer having a melting point of 50° C. or more (preferably 120° C. or less) and being solid at ordinary temperature, selected from plasticizers for polymers used as microcapsule walls, may be used. For example, when the wall material is composed of polyurea or polyurethane, a hydroxy compound, a carbamate compound, an aromatic alkoxy compound, an organic sulfonamide compound, an aliphatic amide compound, an arylamide compound or the like can be preferably used.

The amount of the electron-donating dye precursor applied is preferably from 0.1 g/m² to 3.0 g/m², more preferably 0.2 g/m² to 1.5 g/m², from the viewpoints of color density and background fog.

—Electron-Accepting Compound—

The thermosensitive recording layer in the invention contains at least one electron-accepting compound which reacts with the electron-donating dye precursor thereby allowing the precursor to develop a color. The electron-accepting compound can be suitably selected from those known in the art.

The electron-accepting compound in the invention is preferably at least one of compounds represented by Formula (I). By including the compound as an electron-accepting compound, the thermosensitive recording layer can attain higher sensitivity with excellent image gradation reproduction by keeping background fog low and suppressing printing blurring and can also simultaneously improve the storage characteristics of a formed image for a long time (image storage characteristics), chemical resistance, ink jet suitability, and head matching property with a thermal head.

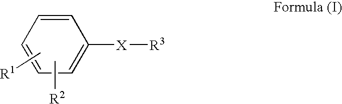

In Formula (I), R¹ and R² independently represent a hydrogen atom, an alkyl group, an alkenyl group, a hydroxy group, a halogen atom or —SO₂Ar, and R represents —Ar, —NH-Ar or —NH—CO—NH—Ar, wherein Ar represents an aromatic ring. The aromatic ring may be substituted by at least one member selected from substituents including a hydroxy group, an alkyl group, an alkenyl group, an alkoxy group, a halogen atom and —SO₂Ar.

X represents a divalent linking group represented by any of the followings:

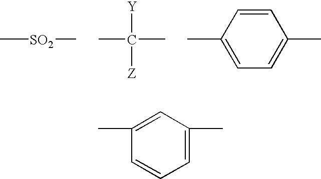

wherein Y and Z independently represent a hydrogen atom or an alkyl group, and Y and Z may bond to each other to form a ring. The alkyl group represented by Y or Z is preferably an alkyl group having 1 to 12 carbon atoms, and more preferably an alkyl group having 1 to 8 carbon atoms. Specific examples of the alkyl group can include a methyl group, an ethyl group, a propyl group, a butyl group and a hexyl group.

At least one of R¹ and R² is preferably a hydroxy group.

The alkyl group represented by R¹ or R² is preferably an alkyl group having 1 to 4 carbon atoms, more preferably a methyl group, an ethyl group, an isopropyl group or a t-butyl group. The alkenyl group represented by R¹ or R² is preferably a vinyl group or an allyl group. The halogen atom represented by R¹ or R² is preferably a fluorine atom, a chlorine atom or a bromine atom.

The above-mentioned Ar is preferably a benzene ring or naphthalene ring which may have a substituent. The substituent is preferably a hydroxy group, an alkyl group (for example, a methyl group, an ethyl group, an isopropyl group etc.), an alkenyl group (for example, a vinyl group, an allyl group etc.), an alkoxy group (for example, a methoxy group, an ethoxy group, an isopropyloxy group etc.), a halogen atom (for example, a fluorine atom, a chlorine atom, a bromine atom etc.), or a substituent containing -SO₂Ar. The “substituent group containing —SO₂Ar” includes —CH₂—C₆H₄—NHCONH—SO₂—C₆H₅, —CH₂—C₆H₄—NHCONH—SO₂—C₆H₄—CH₃, —SO₂—C₆H₅, —SO₂—C₆H₄—CH₃, —SO₂—C₆H₄—Cl, and so on.

In the invention, preferable specific examples of the compounds represented by the above formula (I) above include
2,4-bis(phenylsulfonyl)phenol, 4-hydroxybenzene sulfonanilide (═
p-N-phenylsulfamoylphenol), p-N-(2-chlorophenyl)sulfamoylphenol,
p-N-3-tolylsulfamoylphenol, p-N-2-tolylsulfamoylphenol,
p-N-(3 -methoxyphenyl)sulfamoylphenol,
p-N-(3 -hydroxyphenyl)sulfamoylphenol,
p-N-(4-hydroxyphenyl)sulfamoylphenol, 2-chloro-4-N-phenylsulfamoylphenol,
2-chloro-4-N-(3-hydroxyphenyl)sulfamoylphenol, 4′-hydroxy-p-toluene sulfonanilide, 4,4′-bis(p-toluenesulfonylaminocarbonylamino) diphenylmethane (═BTUM), 4-hydroxy-4′-isopropoxydiphenylsulfone,
2,2′-bis(4-hydroxyphenol)propane (bisphenol A), 4-t-butylphenol,
4-phenylphenol, 4-hydroxydiphenoxide, 1,1′-bis(4-hydroxyphenyl)cyclohexane,
1,1′-bis(3-chloro-4-hydroxyphenyl)cyclohexane,
1,1′-bis(3-chloro-4-hydroxyphenyl)-2-ethylbutane, 4,4′-sec-isooctylidene diphenol, 4,4′-sec-butyrylenediphenol, 4-tert-octylphenol,
4-p-methylphenylphenol, 4,4′-methylcylohexylidene phenol,
4,4′-isopentylidene phenol, 4-[4-(1-methylethoxy)phenylsulfonyl]phenol,
4,4′-(m-phenylenediisopropylidene)diphenol, 3,3′-diallyl-4,4′-dihydroxy diphenylsulfone and benzyl p-hydroxybenzoate.

However, the invention is not limited to these specific examples.

Among the electron-accepting compounds represented by the above Formula (I), 2,4-bis(phenylsulfonyl)phenol, 4-hydroxybenzene sulfonanilide and 4-hydroxy-4′-isopropoxydiphenylsulfone are preferable in view of the balance between image storage characteristics and background fog.

The electron-accepting compound is also preferably any compound selected from salicylic acid derivatives and polyvalent metal salts thereof.

The salicylic acid derivatives include, for example, 4-pentadecylsalicylic acid, 3,5-di(α-methylbenzyl)salicylic acid, 3,5-di(tert-octyl)salicylic acid, 5-octadecylsalicylic acid, 5-α-(p-α-methylbenzylphenyl)ethylsalicylic acid, 3-α-methylbenzyl-5-tert-octylsalicylic acid, 5-tetradecylsalicylic acid, 4-hexyloxysalicylic acid, 4-cyclohexyloxysalicylic acid, 4-decyloxysalicylic acid, 4-dodecyloxysalicylic acid, 4-pentadecyloxysalicylic acid, 4-octadecyloxysalicylic acid,
4-(n-pentanoylamino)salicylic acid, 4-(n-hexanoylamino)salicylic acid,
4-(n-octanoylamino)salicylic acid, 4-(hexadecanoylamino)salicylic acid,
4-(N′-n-butylcarbamoylamino)salicylic acid,
4-(N′-n-hexylcarbamoylamino)salicylic acid,
4-(N′-n-octylcarbamoylamino)salicylic acid,
4-(N′-hexadecylcarbamoylamino)salicylic acid,
4-(n-octyloxycarbonylamino)salicylic acid,
4-(n-nonyloxycarbonylamino)salicylic acid,
4-(n-decyloxycarbonylamino)salicylic acid,
4-(n-undecyloxycarbonylamino)salicylic acid,
4-(n-dodecyloxycarbonylamino)salicylic acid,
4-(n-tridecyloxycarbonylamino)salicylic acid,
4-(n-tetradecyloxycarbonylamino)salicylic acid,
4-(n-pentadecyloxycarbonylamino)salicylic acid,
4-(n-hexadecylcarbonylamino)salicylic acid,
4-(n-octadecyloxycarbonylamino)salicylic acid,
3-(n-octyloxycarbonylamino)salicylic acid,
3-(n-nonyloxycarbonylamino)salicylic acid,
3-(n-decyloxycarbonylamino)salicylic acid,
3-(n-undecyloxycarbonylamino)salicylic acid,
3-(n-dodecyloxycarbonylamino)salicylic acid,
3-(n-tridecyloxycarbonylamino)salicylic acid,
3-(n-tetradecyloxycarbonylamino)salicylic acid,
3-(n-pentadecyloxyloxycarbonylamino)salicylic acid,
3-(n-hexadecyloxycarbonylamino)salicylic acid,
3-(n-octadecyloxycarbonylamino)salicylic acid,
5-(n-octyloxycarbonylamino)salicylic acid,
5-(n-nonyloxycarbonylamino)salicylic acid,
5-(n-decyloxycarbonylamino)salicylic acid,
5-(n-undecyloxycarbonylamino)salicylic acid,
5-(n-dodecyloxycarbonylamino)salicylic acid,
5-(n-tridecyloxycarbonylamino)salicylic acid,
5-(n-tetradecyloxycarbonylamino)salicylic acid,
5-(n-pentadecyloxycarbonylamino)salicylic acid,
5-(n-hexadecyloxycarbonylamino)salicylic acid, and
5-(n-octadecyloxycarbonylamino)salicylic acid.

Polyvalent metal salts of salicylic acid derivatives include zinc, aluminum, calcium, copper or lead salts of the above salicylic acid derivatives.

It is necessary that the amount of the electron-accepting compound in the thermosensitive recording layer is from 5 times to 20 times, preferably from 7 times to 15 times, more preferably 9 times to 12 times, based on mass, to the mass of the electron-donating dye precursor in the thermosensitive recording layer so as to increase the sensitivity and softening the image gradation.

When the amount is lower than 5 times amount, the image gradation becomes hard. When the amount exceeds 20-times amount, the amount of coating of the thermosensitive recording layer is increased and Dmax ( maximum density) becomes low.

In the invention, an electron-accepting compound represented by the above formula (I) and an electron-accepting compound selected from the salicylic acid derivatives and polyvalent metal salts thereof are preferably simultaneously used.

When the known electron-accepting compounds are simultaneously used, the content of the electron-accepting compound represented by the above formula (I) is preferably 50 mass % or more, more preferably 70 mass % or more, based on the total mass of the electron-accepting compounds.

In preparation of a coating solution for forming the thermosensitive recording layer, the particle diameter of the electron-accepting compound is preferably 2.0 μm or less, more preferably from 0.5 μm to 1.2 μm, in terms of volume-average particle diameter. The volume-average particle diameter of 2.0 μm or less is preferable for higher thermosensitivity. The volume-average particle diameter of 0.5 μm or more is preferable because background fog hardly occurs. The volume-average particle diameter can be measured by a laser diffraction particle size distribution measuring instrument (LA500, trade name, manufactured by Horiba, Ltd.).

The electron-accepting compound is dissolved in a water-sparingly-soluble or water-insoluble organic solvent, then mixed with an aqueous phase having a surfactant and a water-soluble polymer as protective colloid, and emulsified to give an emulsified dispersion. In the invention, the resulting emulsified dispersion may be used.

—Sensitizer—

The thermosensitive recording layer in the invention may contain not only the electron-donating dye precursor and the electron-accepting compound but also a sensitizer. By containing the sensitizer, sensitivity can be significantly improved. As the sensitizer in the invention, a known sensitizer can be suitably selected and used. Examples of such sensitizers include 2-benzyloxynaphthalene, dimethylbenzyl oxalate, m-terphenyl, ethylene glycol tolyl ether, p-benzylbiphenyl, 1,2-diphenoxymethylbenzene, 1,2-diphenoxyethane, diphenylsulfone, aliphatic monoamide, aliphatic bisamide, stearyl urea, di(2-methylphenoxy)ethane, di(2-methoxyphenoxy)ethane,
β-naphthol-(p-methylbenzyl) ether, α-naphthyl benzyl ether, 1,4-butanediol p-methylphenyl ether, 1,4-butanediol p-isopropylphenyl ether, 1,4-butanediol p-tert-octylphenyl ether, 1-phenoxy-2-(4-ethylphenoxy)ethane, 1-phenoxy-2-(chlorophenoxy)ethane, 1,4-butanediol phenyl ether, diethylene glycol bis(4-methoxyphenyl) ether and 1,4-bis(phenoxymethyl)benzene. These sensitizers can be used alone or in a combination of two or more of them.

Among the sensitizers described above, at least one member selected from the group consisting of 2-benzyloxynaphthalene, dimethylbenzyl oxalate, m-terphenyl, ethylene glycol tolyl ether, p-benzylbiphenyl, 1,2-diphenoxymethylbenzene, 1,2-diphenoxyethane and diphenylsulfone is particularly preferably contained in the invention.

The total content of the sensitizers in the thermosensitive recording layer is preferably from 75 parts to 200 parts by mass, more preferably from 100 parts to 150 parts by mass, based on 100 parts by mass of the electron-accepting compound. When the content is in the above range, an effect of improving sensitivity is significant, and image storage characteristics can also be improved.

—Inorganic Pigment—

The thermosensitive recording layer in the invention can further contain an inorganic pigment in addition to the electron-donating dye precursor and the electron-accepting compound in such a range that the effect of the invention is not deteriorated. By containing the inorganic pigment, head matching property with a thermal head to be contacted can be further improved.

The inorganic pigment can be suitably selected from those known in the art. Particularly, at least one member selected from calcite-based calcium carbonate, amorphous silica and aluminum hydroxide is preferably contained.

From the viewpoints of improving color density and of preventing a deposit from adhering to a thermal head, the content of the inorganic pigment in the thermosensitive recording layer is preferably from 50 parts to 500 parts by mass, more preferably from 70 parts to 350 parts by mass, still more preferably from 90 parts to 250 parts by mass, based on 100 parts by mass of the electron-accepting compound.

—Adhesive—

The thermosensitive recording layer in the invention preferably contains an adhesive (or a protective colloid at the time of dispersion) in addition to the above essential components. Examples of the adhesive can include polyvinyl alcohol, modified polyvinyl alcohol, a vinyl acetate-acrylamide copolymer, starch, modified starch, methyl cellulose, carboxymethyl cellulose, hydroxymethyl cellulose, gelatins, gum arabic, casein, styrene-maleic acid copolymer hydrolysates, polyacrylamide derivatives, polyvinyl pyrrolidone, and latexes such as styrene-butadiene rubber latex, acrylonitrile-butadiene rubber latex, methyl acrylate-butadiene rubber latex, and vinyl acetate emulsion.

In the invention, the adhesive is particularly preferably polyvinyl alcohol, and modified polyvinyl alcohols such as sulfo modified polyvinyl alcohol, diacetone modified polyvinyl alcohol and acetoacetyl modified polyvinyl alcohol can also be used. By containing the modified polyvinyl alcohol as adhesive in the thermosensitive recording layer, the adhesion between the thermosensitive recording layer and the support can be increased, and troubles such as paper peel in offset printing can be prevented, and printing suitability can be improved. Further, color density upon recording with a thermal head can further be improved while background fog is kept low.

The above-mentioned polyvinyl alcohol may be used alone or in a combination of two or more of them or in combination with other modified polyvinyl alcohol or polyvinyl alcohol. When the other modified polyvinyl alcohol or polyvinyl alcohol are used, the content of the above-mentioned modified polyvinyl alcohol is preferably 10 mass % or more, more preferably 20 mass % or more, based on the total mass of the adhesive components.

The degree of saponification of the above-mentioned polyvinyl alcohol is preferably from 85mol % to 99 mol %. When the degree of saponification is 85 mol % or more, water resistance to dampening water used in offset printing can be maintained. As a result, paper peel can be prevented. When the degree of saponification is 99 mol % or less, undissolved materials do not generate in preparation of the coating solution, and generation of insufficient coating can be prevented. When the other modified polyvinyl alcohol and polyvinyl alcohol are simultaneously used, the other modified polyvinyl alcohol and polyvinyl alcohol preferably have degrees of saponification in the above range in order to prevent deterioration in the effect of the invention.

The degree of polymerization of the above-mentioned polyvinyl alcohol is preferably 200 to 2000. When the degree of polymerization is 200 or more, paper peel upon offset printing can be prevented. When the degree of polymerization is 2000 or less, the polyvinyl alcohol can be easily dissolved in a solvent (water), and an increase in liquid viscosity at the time of preparation can be prevented, and thus preparation and application of a coating solution for forming the thermosensitive recording layer can be well conducted. When the other modified polyvinyl alcohols and polyvinyl alcohols are simultaneously used, the other modified polyvinyl alcohols and polyvinyl alcohols preferably have degrees of saponification in the above range in order to prevent deterioration in the effect of the invention.

The degree of polymerization refers to an average degree of polymerization as determined by a method described in JIS-K6726 (1994). From the viewpoints of improving color density and of imparting offset printing suitability (prevention of paper peel etc.), the content of the polyvinyl alcohols in the thermosensitive recording layer is preferably from 30 parts to 300 parts by mass, more preferably from 70 parts to 200 parts by mass, still more preferably from 100 parts to 170 parts by mass, based on 100 parts of the electron-donating dye precursor. The polyvinyl alcohol not only functions as an adhesive for improving interlayer adhesion but also functions as a dispersant, a binder and so on.

—Image Stabilizer—

Preferably the thermosensitive recording layer in the invention further contains an image stabilizer (containing an ultraviolet absorber) in addition to the above essential components. The ultraviolet absorber may be encapsulated into microcapsules. By containing the image stabilizer, the storage characteristics of a color image formed (image storage characteristics) can further be improved.

For example, a phenol compound, particularly a hindered phenol compound, is effective as the image stabilizer. Examples of the image stabilizer include 1,1,3-tris(2-methyl-4-hydroxy-5-tert-butylphenyl)butane,
1,1,3-tris(2-methyl-4-hydroxy-5-cyclohexylphenyl)butane,
1,1,3-tris(2-ethyl-4-hydroxy-5-cyclohexylphenyl)butane,
1,1,3-tris(3,5-di-tert-butyl-4-hydroxyphenyl)butane,
1,1,3-tris(2-methyl-4-hydroxy-5-tert-butylphenyl)propane,
2,2′-methylene-bis(6-tert-butyl-4-methylphenol),
2,2′-methylene-bis(6-tert-butyl-4-ethylphenol),
4,4′-butylidene-bis(6-tert-butyl-3 -methylphenol),
4,4′-thio-bis-bis(3-methyl-6-tert-butylphenol) etc. The image stabilizers may be used alone or in a combination of two or more of them.

Among these compounds,
1,1,3-tris(2-methyl-4-hydroxy-5-tert-butylphenyl)butane and
1,1,3-tris(2-methyl-4-hydroxy-5-cyclohexylphenyl)butane are particularly preferable.

From the viewpoints of preventing background fog and of effectively improving image storage characteristics, the total content of the image stabilizers in the thermosensitive recording layer is preferably from 10 parts to 100 parts by mass, more preferably from 20 parts to 60 parts by mass, based on 100 parts by mass of the electron-donating dye precursor. When 1,1,3-tris(2-methyl-4-hydroxy-5-tert-butylphenyl)butane and/or 1,1,3-tris(2-methyl-4-hydroxy-5-cyclohexylphenyl)butane are used in combination with the other image stabilizers described above, the content of 1,1,3-tris(2-methyl-4-hydroxy-5-tert-butylphenyl)butane and/or 1,1,3-tris(2-methyl-4-hydroxy-5-cyclohexylphenyl)butane in the single thermosensitive recording layer is preferably 50 mass % or more, more preferably 70 mass % or more, based on the total mass of the image stabilizers.

The ultraviolet absorber can include ultraviolet compounds shown below.

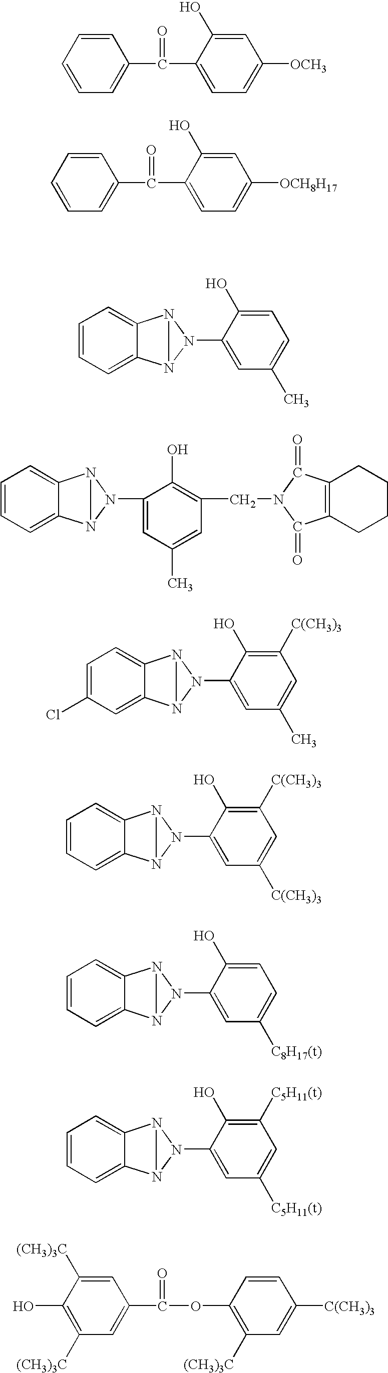

From the viewpoint of effectively improving image storage characteristics, the content the ultraviolet absorber in a single thermosensitive recording layer is preferably from 10 parts to 300 parts by mass, more preferably from 30 parts to 200 parts by mass, based on 100 parts by mass of the electron-donating dye precursor.

—Other Components—

Depending on the object and necessity, the thermosensitive recording layer in the invention may also contain other components such as a crosslinking agent, a mordant, a metal soap, wax, a surfactant, an antistatic agent, a defoaming agent and a fluorescent dye, in addition to the components described above.

—Crosslinking Agent—

The thermosensitive recording layer may also contain a crosslinking agent acting on the modified polyvinyl alcohol or the like used as the adhesive (or protective colloid). By containing the crosslinking agent, water resistance of the thermosensitive recording material can be improved. The crosslinking agent can be suitably selected from those capable of crosslinking the modified polyvinyl alcohol. An aldehyde compound such as glyoxal or a dihydrazide compound such as adipic acid dihydrazide is particularly preferable as the crosslinking agent. The content of the crosslinking agent in the thermosensitive recording layer is preferably from 1 parts to 50 parts by mass, more preferably from 3 parts to 20 parts by mass, based on 100 parts by mass of the modified polyvinyl alcohol or the like as the object of cross-linkage. When the content of the crosslinking agent is in the range described above, water resistance can be effectively improved.

—Metal Soap, Wax and Surfactant—

The metal soap includes higher fatty acid metal salts. Specific examples include zinc stearate, calcium stearate, aluminum stearate and so on.

The wax includes, for example, paraffin wax, microcrystalline wax, carnauba wax, methylol stearoamide, polyethylene wax, polystyrene wax, and fatty acid amide-based wax. These waxes may be used alone or in a combination of two or more of them.

The surfactant includes, for example, a sulfosuccinic acid-based alkali metal salt, a fluorine-containing surfactant, and so on.

[Preparation of Thermosensitive Recording Material]

When the thermosensitive recording layer in the thermosensitive recording material of the invention contains an electron-donating dye precursor, an electron-accepting compound, an inorganic pigment, an adhesive and a sensitizer, for example, these components are subjected simultaneously or separately to dispersion using a stirrer/pulverizer such as a ball mill, an atrighter, a sand mill and can be prepared as a coating solution. If necessary, the above-mentioned other components, that is, a crosslinking agent, a mordant, a metal soap, wax, a surfactant, a binder, an antistatic agent, a defoaming agent and a fluorescent dye are added to the coating solution.

A coating solution is prepared as mentioned above, and the coating solution is coated on the surface of the support to form the thermosensitive recording layer. The coating method for coating the coating solution is not specifically limited, and may be suitably selected from coating methods using, for example, an air knife coater, a roll coater, a blade coater, a curtain coater, a wire bar or the like, and the coating solution is then dried after the coating. After the drying, the coating is preferably smoothed by calendar treatment, and subjected to use. The dry coating amount of the coating solution for coating the thermosensitive recording layer is preferably lower than 12 g/m², and more preferably 10 g/m² or less.

In the invention, a curtain coating method of using a curtain coater is preferable in that high density (high sensitivity) can be achieved with a small amount of the materials used, and simultaneously image quality can also be improved. When a protective layer or the like is also laminated in addition to the thermosensitive recording layer as described later, a plurality of such layers are simultaneously applied in the form of a multilayer by the curtain coating method, whereby the consumption energy at the time of production can further be reduced. This can be carried out specifically in the following manner.

The thermosensitive recording material is produced preferably by curtain coating a single coating solution or a plurality of coating solutions onto the surface of a support and then drying a single layer or a part or all of layers thus arranged on the support. The type of layer formed by curtain coating is not particularly limited. The type of layer includes an undercoat layer, thermosensitive recording layer and protective layer. It is also a preferable embodiment that a series of these adjacent layers are simultaneously applied in the form of a multilayer by curtain coating.

Specific combinations of layers in the case of simultaneous multilayer coating include, but are not limited to, a combination of the undercoat layer and the thermosensitive recording layer, a combination of the thermosensitive recording layer and the protective layer, a combination of the undercoat layer, the thermosensitive recording layer and the protective layer, a combination of two or more of different undercoat layers, a combination of two or more of different thermosensitive recording layers, and a combination of two or more of different protective layers.

A curtain coater used in curtain coating is not particularly limited. The curtain coater includes an extrusion hopper type curtain coater and a slide hopper type curtain coater. Among these curtain coaters, a slide hopper type curtain coater, described in JP-B No. 49-24133, that is used in producing a photosensitive material is particularly preferable. Simultaneous multilayer coating can be easily carried out by using this slide hopper type curtain coater.

[Protective Layer]

In the invention, at least one protective layer is preferably arranged on the thermosensitive recording layer, from the viewpoints of image storage characteristics and head matching property with a thermal head. The protective layer can be constructed by containing organic or inorganic fine powders, a binder, a surfactant, a thermoplastic substance and so on.

The fine powder includes, for example, inorganic fine powders such as calcium carbonate, silica, zinc oxide, titanium oxide, aluminum hydroxide, zinc hydroxide, barium sulfate, kaolin, clay, talc, and surface-treated calcium, silica or the like, and organic fine powders such as an urea-formalin resin, a styrene/methacrylic acid copolymer, polystyrene or the like.

Examples of the binder to be incorporated in the protective layer may include polyvinyl alcohol, modified polyvinyl alcohol, vinyl acetate-acrylamide copolymer, silicon-modified polyvinyl alcohol, starch, modified starch, methyl cellulose, carboxymethyl cellulose, hydroxymethyl cellulose, gelatins, gum arabic, casein, hydrolysates of styrene-maleic acid copolymer, polyacrylamide derivatives, polyvinyl pyrrolidone, latexes such as styrene-butadiene rubber latex, acrylonitrile-butadiene rubber latex, methyl acrylate-butadiene rubber latex and vinyl acetate emulsion, and the like.

Furthermore, an exemplary embodiment in which a waterproofing agent is added so that the binder component in the protective layer is crosslinked to further improve the storage stability of the thermosensitive recording material is also preferable. Examples of the waterproofing agent may include water-soluble initial condensates such as N-methylolurea, N-methylolmelamine and urea-formalin; dialdehyde compounds such as glyoxal and glutaraldehyde; inorganic crosslinking agents such as boric acid, boric sand, colloidal silica and Zr salts; polyamide epichlorohydrin; and the like.

It is a particularly preferable embodiment that the protective layer comprises a water-soluble polymer and at least one of inorganic pigments selected from aluminum hydroxide, kaolin and an amorphous silica. By constituting the protective layer in this embodiment, storage characteristics can be improved, and simultaneously handling ability and printing suitability can also be imparted. The protective layer can also contain a surfactant, a thermofusible substance and so on.

The volume-average particle diameter of the inorganic pigment contained in the protective layer is preferably from 0.5 μm to 3 μm, more preferably from 0.7 μm to 2.5 μm. Measurement of the volume-average particle diameter can be carried out a similar manner to that described above for the electron-donating dye precursor, etc.

The total content of the inorganic pigments selected from aluminum hydroxide, kaolin and amorphous silica is preferably from 10 mass % to 90 mass %, and more preferably from 30 mass % to 70 mass %, with respect to the total amount of solids (mass) of the coating solution for forming the protective layer. Furthermore, other pigments such as barium sulfate, zinc sulfate, talc, clay and colloidal silica may be used in combination to the extent that the effect of the invention is not deteriorated.

The water-soluble polymer includes, among the above-mentioned binders, polyvinyl alcohol and modified polyvinyl alcohol (hereinafter referred to collectively as “polyvinyl alcohol”), starch and modified starch such as oxidized starch and urea phosphate starch, and carboxy group-containing polymers such as a styrene-maleic anhydride copolymer, a styrene-maleic anhydride copolymer alkyl ester, and a styrene-acrylic acid copolymer. Particularly from the viewpoint of printing suitability, polyvinyl alcohol, oxidized starch, and urea phosphate starch are preferable and are particularly preferably used in a mixture such that the mass ratio (x/y) of polyvinyl alcohol (x) to oxidized starch and/or urea phosphate starch (y) is from 90/10 to 10/90. Particularly, when all of the polyvinyl alcohol, oxidized starch and urea phosphate starch are simultaneously used, the mass ratio (y¹/y²) of oxidized starch (y¹) to urea phosphate starch (y²) is preferably from 10/90 to 90/10.

The modified polyvinyl alcohol is preferably acetoacetyl modified polyvinyl alcohol, diacetone modified polyvinyl alcohol, silicon modified polyvinyl alcohol, amide modified polyvinyl alcohol, or alkyl ether modified polyvinyl alcohol, and besides, sulfo modified polyvinyl alcohol, carboxy modified polyvinyl alcohol and so on. are used. When a crosslinking agent that reacts with these polyvinyl alcohols is simultaneously used, storage characteristics, handling ability and printing suitability can be further improved.

The mass ratio of the water-soluble polymer to the total amount of solids (mass) of the coating solution for forming the protective layer is preferably from 10 mass % to 90 mass %, more preferably from 30 mass % to 70 mass %.

Preferable examples of the crosslinking agent for crosslinking the water-soluble polymer include polyvalent amine compounds such as ethylenediamine, polyvalent aldehyde compounds such as glyoxal, glutaraldehyde and dialdehyde, dihydrazide compounds such as adipic acid dihydrazide and phthalic acid dihydrazide, water-soluble methylol compounds (urea, melamine, phenol), multifunctional epoxy compounds, polyvalent metal salts (Al, Ti, Zr, Mg etc.). In particular, polyvalent aldehyde compounds and dihydrazide compounds are preferable.

The mass ratio (%) of the crosslinking agent to the water-soluble polymer is preferably from about 2 mass % to about 30 mass %, and more preferably from 5 mass % to 20 mass %. By containing the crosslinking agent, film strength, water resistance and so on. can be further improved. Although the mixing ratio of the inorganic pigment selected from aluminum hydroxide, kaolin and amorphous silica to the water-soluble polymer in the protective layer varies depending on the type and particle diameter of the inorganic pigment and the type of the water-soluble polymer, the amount of the water-soluble polymer is preferably from 50 mass % to 400 mass %, more preferably from 100 mass % to 250 mass %, based on the mass of the inorganic pigment. The total mass of the inorganic pigment and the water-soluble polymer in the protective layer is preferably 50 mass % or more of the total mass of solids of the protective layer.

Preferable examples of the surfactant include alkylbenzene sulfonates such as sodium dodecylbenzenesulfonate, alkyl sulfosuccinates such as a sodium dioctylsulfosuccinate, polyoxyethylene alkyl ether phosphates, sodium hexametaphosphate, perfluoroalkyl carboxylates and so on. Among them, alkyl sulfosuccinates are more preferable. The content of the surfactant is preferably 0.1 mass % to 5 mass %, more preferably 0.5 mass % to 3 mass %, based on the total amount of solids (mass) of the coating solution for forming the protective layer.

A coating solution for forming the protective layer can be prepared by dissolving or dispersing the water-soluble polymer, the inorganic pigment selected from aluminum hydroxide, kaolin and amorphous silica, and if necessary, a crosslinking agent, a surfactant etc. described above in a desired aqueous solvent. A lubricant, a defoaming agent, a fluorescent brightener, a colored organic pigment and so on can be added to the coating solution in such a range that the effect of the invention is not deteriorated. The lubricant includes, for example, metal soap such as zinc stearate and calcium stearate and wax such as paraffin wax, microcrystalline wax, carnauba wax and synthetic polymer wax.

[Support]

The thermosensitive recording material of the invention comprises a thermosensitive recording layer coated on a support. As the support, a support known in the art can be suitably selected and used. Specific examples of the support include a paper support such as high-quality paper, coated paper having a pigment applied onto paper, resin-coated paper having resin applied onto paper, resin-laminated paper, high-quality paper having a undercoat layer, synthetic paper, and a transparent support such as plastic film. A support mainly including recycled pulp, that is, a support wherein recycled pulp accounts for 50 mass % of the support, can also be used.

As the above-mentioned support, a smooth support having smoothness of 500 seconds or more as defined by JIS-P8119 is preferable in view of dot reproducibility.

In the invention, the support is preferably one selected from a transparent support, a synthetic paper and resin-coated paper.

When the support is a transparent support, synthetic paper or a resin-coated paper, smoothness can be made particularly high, and particularly dot reproducibility is excellent, and when an actual image is observed with the naked eye, image quality excellent in image reproducibility in a wide region from a low-density potion to a high-density portion can be obtained.

An undercoat layer may be arranged between the support described above and the thermosensitive recording layer. In this case, the undercoat layer is preferably arranged on the surface of a support having a stockigt sizing degree of 5 seconds or more and preferably consists primarily of a pigment and a binder. As a pigment for the undercoat layer, any conventional inorganic and organic pigments can be used. The pigment is particularly preferably an oil-absorbing pigment having an oil absorbency of 40 mL/100 g (cc/100 g) or more as defined in JIS-K5101. Specific examples of the oil-absorbing pigment include calcined kaolin, aluminum oxide, magnesium carbonate, calcinated diatomaceous earth, aluminum silicate, magnesium aluminosilicate, calcium carbonate, barium sulfate, aluminum hydroxide, kaolin, amorphous silica, urea formalin resin powder, and so on. Among them, calcined kaolin having an oil absorbency of from 70 mL/100 g to 80 mL/100 g is particularly preferable.

When the undercoat layer is formed by application onto a support, the amount of the pigment applied is preferably 2 g/m² or more, more preferably 4 g/m² or more, and even more preferably from 7 g/m² to 12 g/m².

The binder for the undercoat layer includes a water-soluble polymer and an aqueous binder. These can be used alone itself or in a combination of two or more of them. The water-soluble polymer includes, for example, starch, polyvinyl alcohol, polyacrylamide, carboxymethyl cellulose, methyl cellulose, casein and so on. The aqueous binder is generally synthetic rubber latex or synthetic resin emulsion, and examples of the aqueous binder include styrene-butadiene rubber latex, acrylonitrile-butadiene rubber latex, methyl acrylate-butadiene rubber latex, vinyl acetate emulsion, and so on.

The amount of the binder used for the undercoat layer is determined in consideration of the balance among film strength, the thermosensitivity of the thermosensitive recording layer and so on. The amount of the binder used for the undercoat layer is preferably from 3 mass % to 100 mass %, more preferably from 5 mass % to 50 mass %, still more preferably from 8 mass % to 15 mass %, based on the mass of the pigment for the undercoat layer. The undercoat layer may also include wax, a discoloration inhibitor, a surfactant and so on.

Coating of the coating solution for forming the undercoat layer can be carried out by methods known in the art. Specific examples include coating methods of using an air knife coater, a roll coater, a blade coater, a gravure coater, a curtain coater and so on. Among them, coating methods of using a curtain coater or a blade coater are preferable, and a coating method of using a blade coater is more preferable. After coating and drying, the undercoat layer may be further subjected to smoothing treatment such as calendar treatment, if necessary.

The method of using a blade coater includes not only coating methods of using a blade of bevel- or bent-type but also a rod blade coating method and a bill blade coating method. Coating may be carried out by an off-machine coater or by an on-machine coater arranged on a paper-making machine. For giving excellent smoothness and planarity by imparting fluidity at the time of blade coating, the coating solution for forming the undercoat layer (coating solution for undercoat layer) may include carboxymethyl cellulose having an etherification degree of 0.6 to 0.8 and a weight-average molecular weight of 20000 to 200000, in an amount of 1 mass % to 5 mass %, preferably 1 mass % to 3 mass %, based on the amount of the pigment described above.

The amount of the undercoat layer applied is not particularly limited. Depending on the characteristics of the thermosensitive recording material, the amount of the undercoat layer applied is preferably 2 g/m² or more, more preferably 4 g/m² or more, and still more preferably from 7 g/m² to 12 g/m².

In the invention, a primed base paper having an undercoat layer (particularly preferably an oil-absorbing undercoat layer having heat insulating properties and high planarity) is preferable, and a primed base paper having an undercoat layer containing an oil-absorbing pigment, formed by using a blade coater, is particularly preferable, from the viewpoints of improving head matching property with a thermal head and of attaining higher sensitivity and image qualities.

The total ion concentration of monovalent ion such as Na⁻ ion, K⁺ ion, or the like that is possessed by the thermosensitive recording material is preferably 1500 ppm or less, more preferably 1000 ppm or less, and specifically preferably 800 ppm or less, from the viewpoint of prevention of head corrosion of the thermal head that contacts with the thermosensitive recording material. The ion concentration of the above-mentioned Na⁺ ion, K⁺ ion or the like may be measured by measuring the ion mass by ion quantitative analysis method in which the thermosensitive recording material is extracted with hot water and the extracted water is subjected to atomic absorption spectrometry. The above-mentioned total ion concentration is represented by ppm with respect to the total mass of the thermosensitive recording material.

### EXAMPLES

Hereinafter the present invention is explained more specifically with referring to Examples, but the invention is not limited to the specific examples mentioned below. The “part(s)” refers to “part(s) by mass” and “%” refers to “% by mass” unless specifically mentioned.

### Example 1

[Preparation of Electron-Donating Dye Precursor Dispersion Liquid]

20 parts of 3-N,N-dibutylamino-6-methyl-7-anilinofluoran were mixed with 80 parts of 0.5% aqueous solution of polyvinyl alcohol (trade name: PVA-105, manufactured by Kuraray Co., Ltd.). After mixing, the mixture was milled with a sand mill to prepare an electron-donating dye precursor dispersion liquid (A) having a volume-average particle diameter of 0.6 μm. The volume average-particle diameter was measured using a laser diffraction particle size distribution measuring instrument (LA500, trade name, manufactured by Horiba, Ltd.).

[Preparation of Sensitizer Dispersion Liquid]

20 parts of 1,2-bis(3-methylphenoxy)ethane were mixed with 80 parts of a 5% aqueous solution of polyvinyl alcohol (PVA-105). After mixing, the mixture was milled with a sand mill to prepare a sensitizer dispersion liquid having a volume average-particle diameter of 0.6 μm. The volume average-particle diameter was measured using a laser diffraction particle size distribution measuring instrument (trade name: LA500, manufactured by Horiba, Ltd.).

[Preparation of Developer Dispersion Liquid]

20 parts of 2,4-bis(phenylsulfonyl)phenol were mixed with 80 parts of a 5% aqueous solution of polyvinyl alcohol (PVA-105). After mixing, the mixture was milled with a sand mill to prepare a developer dispersion liquid (A) having a volume average-particle diameter of 0.6 μm. The volume average-particle diameter was measured using a laser diffraction particle size distribution measuring instrument (trade name: LA500, manufactured by Horiba, Ltd.).

[Preparation of Coating Solution for Thermosensitive Recording Layer]

3 parts of the above-mentioned electron-donating dye precursor dispersion liquid (A), 1 part of the sensitizer dispersion liquid, 20 parts of the developer dispersion liquid (A), 0.8 parts of HYDRIN Z-7 (trade name, manufactured by Chukyo Yushi Co., Ltd.) at a concentration of 31%, 0.8 parts of HYDRIN D337 (trade name, manufactured by Chukyo Yushi Co., Ltd.) at a concentration of 31%, 1.0 parts of a 2% aqueous solution of sodium (2-ethylhexyl)sulfosuccinate and 9 parts of water were mixed to give a coating solution for thermosensitive recording layer (1).

[Preparation of Thermosensitive Recording Material]

High-quality paper having smoothness by JIS-P8119 of 300 seconds was prepared as a support. The coating solution for thermosensitive recording layer (1) was coated using a wire bar on the surface of the high-quality paper so that the mass of the thermosensitive recording layer after drying became 6.0 g/m², dried in an oven at 50° C. and subjected to calendar treatment to give thermosensitive recording material (1).

### Example 2

[Preparation of Coating Solution for Protective Layer]

50 parts of polyvinyl alcohol (trade name: EP-130, manufactured by Denki Kagaku Kogyo Kabushiki Kaisha) at a concentration of 5%, 0.8 part of HYDRIN Z-7 (trade name, manufactured by Chukyo Yushi Co., Ltd.) at a concentration of 31%, 0.8 part of HYDRIN D337 (trade name, manufactured by Chukyo Yushi Co., Ltd.) at a concentration of 31%, 2.5 parts of zirconium sulfate at a concentration of 1% and 30 parts of water were mixed to give a coating solution for protective layer.

[Preparation of Coating Solution for Thermosensitive Recording Layer]

The coating solution for thermosensitive recording layer (2) was obtained according to a similar manner to that in Example 1 except that the amount of the developer dispersion liquid (A) was changed to 30 parts in the preparation of the coating solution for thermosensitive recording layer (1) in Example 1.

[Preparation of Thermosensitive Recording Material]

Synthetic paper (trade name: TOYOPEARL SS, manufactured by TOYOBO CO., LTD.) having a thickness of 80 μm was used as a support. The coating solution for thermosensitive recording layer (2) was applied on the surface of the support using a wire bar so that the mass of the thermosensitive recording layer after drying would become 8.0 g/m², and this was dried in an oven at 50° C. to form the thermosensitive recording layer. The coating solution for protective layer was applied on the thermosensitive recording layer so that the mass of the protective layer after drying would become 2.0 g/m², and this was dried in an oven at 50° C. and subjected to calendar treatment to obtain thermosensitive recording material (2).

### Example 3

Thermosensitive recording material (3) was obtained according to a similar manner to that in Example 1 except that the amount of the developer dispersion liquid (A) was changed to 15 parts in the preparation of the coating solution for thermosensitive recording layer (1) in Example 1.

### Example 4

Thermosensitive recording material (4) was obtained according to a similar manner to that in Example 1 except that the amount of the developer dispersion liquid (A) was changed to 60 parts in the preparation of the coating solution for thermosensitive recording layer (1) in Example 1.

### Example 5

[Preparation of Developer Dispersion Liquid]

20 parts of 4-[4-(1-methylethoxy)phenylsulfonyl]phenol (trade name: D-8, manufactured by Nippon Soda Co., Ltd.) and 80 parts of a 5% aqueous solution of polyvinyl alcohol (PVA-105) were mixed. The mixture was milled using a sand mill to prepare a developer dispersion liquid (B) having an average particle diameter of 0.6 μm.

[Preparation of Coating Solution for Thermosensitive Recording Layer]

A coating solution for thermosensitive recording layer (5) was obtained according to a similar manner to that in Example 1 except that 30 parts of the above-mentioned developer dispersion liquid (B) was used instead of the developer dispersion liquid (A) in the preparation of the coating solution for thermosensitive recording layer (1) in Example 1.

[Preparation of Thermosensitive Recording Paper]

The above-mentioned coating solution for thermosensitive recording layer (5) and the coating solution for protective layer were sequentially applied using a wire bar on the surface of a resin-coated paper support (20 g of polyethylene had been laminated on both surfaces of 80 g base paper) so that the weight of the thermosensitive recording layer after drying became 7.0 g/m² and the weight of the protective layer became 2.0 g/m², dried in an oven at 50° C., and subjected to calendar treatment to give thermosensitive recording material (5).

### Example 6

Thermosensitive recording material (6) was obtained in a similar manner to that in Example 5 except that the developer in the developer dispersion liquid (B) of Example 5 was changed to 4,4′-(m-phenylenediisopropylidene)diphenol.

### Example 7

Thermosensitive recording material (7) was obtained in a similar manner to Example 5 except that the developer in the developer dispersion liquid (B) of Example 5 was changed to 3,3′-diallyl-4,4′-dihydroxybiphenylsulfone.

### Example 8

[Preparation of Electron-Donating Dye Precursor Dispersion Liquid]

20 parts of 6′-{ethyl(3-methylbutyl)amino}-3′-methyl-2′-(phenylamino)-fluoran were mixed with 80 parts of a 5% aqueous solution of polyvinyl alcohol (trade name: PVA-105, manufactured by Kuraray Co., Ltd.). The mixture was milled using a sand mill to prepare an electron-donating dye precursor dispersion liquid (B) having a volume average-particle size of 0.6 μm. The volume average-particle diameter was measured using a laser diffraction particle diameter distribution measuring instrument (trade name: LA500, manufactured by Horiba, Ltd.).

Thermosensitive recording material (8) was obtained in a similar manner to that in Example 2 except that the electron-donating dye precursor dispersion liquid (A) was changed to the electron-donating dye precursor dispersion liquid (B) in Example 2.

### Example 9

Thermosensitive recording material (9) was obtained in a similar manner to that in Example 8 except that the dye in the electron-donating dye precursor dispersion liquid (B) of Example 8 was changed to 2-anilino-3 -methyl-6-(N-methyl-N-propylamino)-fluoran.

### Example 10

<Preparation of Electron-Donating Dye Precursor-Enclosed Microcapsule Liquid>

14 g of 2-anilino-3-methyl-6-N-ethyl-N-sec-butylaminofluoran as an electron-donating dye precursor, 0.6 g of CINUBIN P (trade name, manufactured by Ciba Geigy Corporation) as an ultraviolet absorber, and 10 g of TAKENATE D-110N (trade name, manufactured by Takeda Chemical Industries, Ltd.) and 10 g of SUMIJUL N3200 (trade name, manufactured by Sumitomo Chemical Co., Ltd.) as a capsule wall agent were dissolved in 20 g of ethyl acetate. The solution was mixed with 112 g of a 5% aqueous solution of polyvinyl alcohol (trade name: PVA217C, manufactured by Kuraray Co., Ltd.). The mixture was emulsified using an ACE HOMOGENIZER (trade name, manufactured by Nippon Seiki Co., Ltd.) at 8000 rpm for 5 minutes, then 142 g of water was further added thereto, and the mixture was allowed to react at 55° C. for 3 hours to prepare an electron-donating dye precursor-containing microcapsule liquid (capsule size: 0.7 μm).

<Preparation of Developer Emulsion Dispersion>

7 g of developer (a), 7 g of developer (b), 16 g of developer (c) and 11 g of developer (d) represented by the following structural formulas, 1.7 g of tricresyl phosphate, and 0.8 g of diethyl maleate were dissolved in 38 g of ethyl acetate. The obtained developer solution was mixed with an aqueous solution of 100 g of an 8% aqueous solution of polyvinyl alcohol (trade name: PVA205C, manufactured by Kuraray Co., Ltd.), 150 g of water and 0.5 g of sodium dodecylbenzenesulfonate, and the mixture was emulsified using an ACE HOMOGENIZER (trade name, manufactured by Nippon Seiki Co., Ltd.) at 10,000 rpm for 5 minutes under ordinary temperature to obtain a developer emulsified dispersion having an average particle diameter of 1.0 μm.

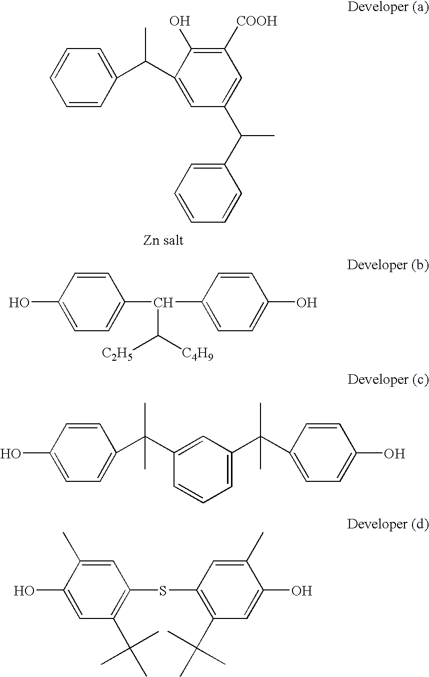

<Preparation of Thermosensitive Recording Material>

<<Formation of Thermosensitive Recording Layer>>

5.0 parts of the above-mentioned electron-donating dye precursor-enclosed microcapsule liquid and 40.0 parts of the developer emulsified dispersion were mixed under stirring to prepare a coating solution for thermosensitive recording layer, and the coating solution was applied on one surface of a transparent polyethylene terephthalate support having a thickness of 75 μm so that the amount of solids became 10 g/m² and dried to form a thermosensitive recording layer.

<<Formation of Protective Layer>>

—Preparation of Pigment Dispersion—

15 parts of aluminum hydroxide treated with zinc stearate (trade name: HIGILITE H 42S, manufactured by Showa Denko K. K.) were added to 60 g of water, 5 parts of 10% polyvinyl alcohol (trade name: PVA205, manufactured by Kuraray Co., Ltd.) and 2 parts of 2% sodium dodecylbenzene sulfonate, and dispersed so that the average particle diameter thereof became 0.7 μm to give a pigment dispersion.

A coating solution for a protective layer was prepared so as to have the following composition based on the solid content, and applied on the thermosensitive recording layer so that the amount of solids became 2.5 g/m².

| | |
|---|---|
| Polyvinyl alcohol | 7 parts |
| (trade name: PVA124, manufactured by Kuraray Co., Ltd.) | |
| The pigment dispersion obtained above | 12 parts |
| Paraffin wax emulsion | 0.9 parts |
| (trade name: Cerozole 428, manufactured by Chukyo Yushi | |
| Co., Ltd.) | |
| Zinc stearate emulsion | 0.2 parts |
| (trade name: Highmicron F115, manufactured by Chukyo | |
| Yushi Co., Ltd.) Polyoxyethylene alkyl ether phosphate | 0.05 parts |
| (trade name: Neoscore CM57, manufactured by Toho | |
| Chemical Industry Co., Ltd.) | |

### Comparative Example 1

A thermosensitive recording material was obtained in a similar manner to that in Example 1 except that the amount of the developer dispersion liquid (A) was changed to 6.0 parts in the preparation of the coating solution for thermosensitive recording layer (1) in Example 1.

### Comparative Example 2

A thermosensitive recording material was obtained in a similar manner to that in Example 2 except that the amount of the developer dispersion liquid (A) was changed to 10 parts.

### Comparative Example 3

A thermosensitive recording material was obtained in a similar manner to that in Example 2 except that the amount of the developer dispersion liquid (A) was changed to 70 parts.

### Comparative Example 4

A thermosensitive recording material was obtained in a similar manner to that in Example 5 except that the amount of the developer dispersion liquid (B) was changed to 8.0 parts.

### Comparative Example 5

A thermosensitive recording material was obtained in a similar manner to that in Example 10 except that the amount of the developer emulsified dispersion was changed to 10 parts.

[Evaluations]

### (Color Forming Property)

Images (step edge) were printed on the obtained thermosensitive recording materials using a thermal printer (trade name: TRT-8, manufactured by Nagano Japan Radio Co., Ltd.) with varying the applied thermal energy of the thermal head, and the color optical density and the background optical density before printing were measured using a densitometer (trade name: RD-918, manufactured by Macbeth). The obtained results are shown in Tables 1 and 2. As a printer used in this technical field, one exhibiting a color density of 1.50 or more is required where the applied thermal energy is 35 mJ/mM².

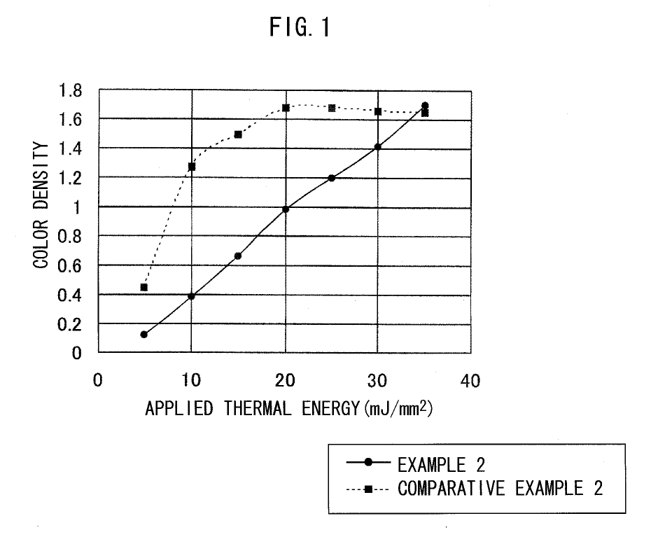

A graph showing the color density with respect to the above-mentioned applied thermal energy in the above-mentioned Example 2 and Comparative Example 2 is shown in FIG. 1. From this graph, it is understood that the color density varies greatly with respect to the applied thermal energy and the gradation reproducibility (soft gradation) is poor in Comparative Example 2, whereas the variation in the color density is small and the gradation reproducibility (soft gradation) is excellent in Example 2.

(Evaluation of Actual Image)

Actual images were printed on the obtained thermosensitive recording materials using a thermal imager (trade name: FTI500, manufactured by Fujifilm Corporation), and the images were visually observed. The obtained results are shown in Tables 1 and 2.

A: image reproducibility is good from the low-density portion to the high-density portion.

B: image reproducibility is bad in the low-density portion or high-density portion.

C: reproducibility is bad in all density areas.

TABLE 1

| | | Thermosensitive recording layer | | | | | | | | |
|---|---|---|---|---|---|---|---|---|---|---|
| | | | | | | | | Mass ratio | | |
| | | | | | | | | of | | |
| | | | Electron-donating | | Developer | | | developer/ | | |
| | | | dye precursor | | Dispersion liquid or | | Mass | electron- | Protective layer | |
| | | | Dispersion liquid | Amount | dispersion and | Amount | after | donating | | Mass after |
| | | Coating | or microcapsule | added | amount added | added | drying | dye | Coating | drying |
| | Support | solution | liquid | (parts) | (parts) | (parts) | (g/m²) | precursor | solution | (g/m²) |
| Example 1 | High- | (1) | Dispersion liquid | 3 | Dispersion liquid | 20 | 6.0 | 6.7 | — | — |
| | quality paper | | (A) | | (A) 20 | | | | | |
| Example 2 | Synthetic paper | (2) | Dispersion liquid | 3 | Dispersion liquid | 30 | 6.0 | 10.0 | Used | 2.0 |
| | | | (A) | | (A) 30 | | | | | |
| Example 3 | High- | (3) | Dispersion liquid | 3 | Dispersion liquid | 15 | 6.0 | 5.0 | — | — |
| | quality paper | | (A) | | (A) 15 | | | | | |
| Example 4 | High- | (4) | Dispersion liquid | 3 | Dispersion liquid | 60 | 6.0 | 20.0 | — | — |
| | quality paper | | (A) | | (A) 60 | | | | | |
| Example 5 | Resin-coated | (5) | Dispersion liquid | 3 | Dispersion liquid | 30 | 7.0 | 10.0 | Used | 2.0 |
| | paper | | (A) | | (A) 30 | | | | | |
| Example 6 | Resin-coated | (6) | Dispersion liquid | 3 | Dispersion liquid | 30 | 7.0 | 10.0 | Used | 2.0 |
| | paper | | (A) | | (A) 30 | | | | | |
| Example 7 | Resin-coated | (7) | Dispersion liquid | 3 | Dispersion liquid | 30 | 7.0 | 10.0 | Used | 2.0 |
| | paper | | (A) | | (A) 30 | | | | | |
| Example 8 | Synthetic paper | (8) | Dispersion liquid | 3 | Dispersion liquid | 30 | 6.0 | 10.0 | Used | 2.0 |
| | | | (B) | | (A) 30 | | | | | |
| Example 9 | Synthetic paper | (9) | Dispersion liquid | 3 | Dispersion liquid | 30 | 6.0 | 10.0 | Used | 2.0 |
| | | | (C) | | (A) 30 | | | | | |
| Example 10 | PET | (10) | Microcapsule-containing | 5 | Emulsified | 40 | 10.0 | 8.0 | Used | 2.5 |
| | | | liquid | | dispersion 40 | | | | | |
| Comparative | High- | (11) | Dispersion liquid | 3 | Dispersion liquid | 6 | 6.0 | 2.0 | — | — |
| Example 1 | quality paper | | (A) | | (A) 6 | | | | | |
| Comparative | Synthetic paper | (12) | Dispersion liquid | 3 | Dispersion liquid | 10 | 6.0 | 3.3 | Used | 2.0 |
| Example 2 | | | (A) | | (A) 10 | | | | | |
| Comparative | Synthetic paper | (13) | Dispersion liquid | 3 | Dispersion liquid | 70 | 6.0 | 23.3 | Used | 2.0 |
| Example 3 | | | (A) | | (A) 70 | | | | | |
| Comparative | Resin- | (14) | Dispersion liquid | 3 | Dispersion liquid | 8 | 7.0 | 2.7 | Used | 2.0 |
| Example 4 | coated paper | | (A) | | (A) 8 | | | | | |
| Comparative | PET | (15) | Micro-capsule | 5 | Emulsified | 10 | 10.0 | 2.0 | Used | 2.5 |
| Example 5 | | | liquid | | dispersion 10 | | | | | |

TABLE 2

| | | Applied thermal energy (mJ/mm²) | | | | | | | |
|---|---|---|---|---|---|---|---|---|---|
| | | 5 | 10 | 15 | 20 | 25 | 30 | 35 | Evaluation of |
| | Background density | Color density | | | | | | | actual image |
| Example 1 | 0.09 | 0.11 | 0.35 | 0.78 | 1.06 | 1.35 | 1.47 | 1.65 | A |
| Example 2 | 0.05 | 0.12 | 0.39 | 0.67 | 0.98 | 1.20 | 1.41 | 1.70 | A |
| Example 3 | 0.08 | 0.15 | 0.48 | 0.91 | 1.25 | 1.47 | 1.66 | 1.89 | A |
| Example 4 | 0.08 | 0.11 | 0.30 | 0.52 | 0.74 | 1.02 | 1.31 | 1.59 | A |
| Example 5 | 0.07 | 0.13 | 0.35 | 0.65 | 0.94 | 1.14 | 1.43 | 1.67 | A |
| Example 6 | 0.05 | 0.12 | 0.31 | 0.62 | 0.89 | 1.16 | 1.48 | 1.72 | A |
| Example 7 | 0.07 | 0.17 | 0.40 | 0.71 | 1.11 | 1.35 | 1.71 | 1.88 | A |
| Example 8 | 0.09 | 0.16 | 0.41 | 0.69 | 0.99 | 1.15 | 1.37 | 1.68 | A |
| Example 9 | 0.06 | 0.14 | 0.35 | 0.62 | 0.96 | 1.20 | 1.39 | 1.72 | A |
| Example 10 | 0.10 | 0.19 | 0.45 | 0.87 | 1.09 | 1.43 | 1.71 | 1.83 | A |
| Comparative Example 1 | 0.10 | 0.25 | 1.15 | 1.79 | 1.8 | 1.8 | 1.80 | 1.79 | C |
| Comparative Example 2 | 0.07 | 0.45 | 1.27 | 1.49 | 1.68 | 1.68 | 1.66 | 1.65 | B |
| Comparative Example 3 | 0.05 | 0.11 | 0.28 | 0.42 | 0.64 | 0.85 | 1.01 | 1.25 | A |
| Comparative Example 4 | 0.07 | 0.15 | 0.78 | 1.72 | 1.75 | 1.75 | 1.75 | 1.75 | C |
| Comparative Example 5 | 0.10 | 0.19 | 0.55 | 1.5 | 1.85 | 1.87 | 1.85 | 1.88 | C |

As is apparent from the Examples in Tables 1 and 2, it is found that the color density is 1.50 or more where the applied thermal energy is 35 mJ/mm², the variation in the color density with respect to the applied thermal energy is small, the color forming property is softened, and good gradation reproducibility (soft gradation) is exhibited in the thermosensitive recording material of the invention. Furthermore, it is also found that good image reproducibility is exhibited in the evaluation of the actual images in the thermosensitive recording material of the invention.

On the other hand, the variation in the color density is significant and the color forming property is a hard gradation in all Comparative Examples.

The invention includes the following embodiments.

<1> A thermosensitive recording material including on a support, a thermosensitive recording layer provided on the support including an electron-donating dye precursor and an electron-accepting compound that makes the electron-donating dye precursor thermally develop a color, wherein the thermosensitive recording layer includes the electron-accepting compound in a ratio of from 5/1 to 20/1 by mass ratio with respect to the electron-donating dye recursor.

<2> The thermosensitive recording material of <1>, wherein the electron-donating dye precursor is selected from fluoran or phthalide compounds.

<3> The thermosensitive recording material of <1>, wherein the electron-accepting compound comprises a compound represented by the following Formula (I):

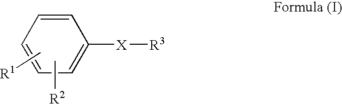

wherein R¹ and R² each independently represent a hydrogen atom, an alkyl group, an alkenyl group, a hydroxy group, a halogen atom or —SO₂Ar, R³ represents —Ar, —NH-Ar or —NH—CO—NH—Ar; Ar represents an aromatic ring; the aromatic ring may be substituted by at least one member selected from a hydroxy group, an alkyl group, an alkenyl group, an alkoxy group, a halogen atom or —SO₂Ar; and X represents a divalent linking group represented by any of the followings:

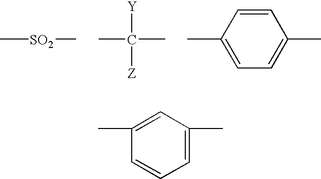

wherein Y and Z each independently represent a hydrogen atom or an alkyl group, and Y and Z may bond to each other to form a ring.

<4> The thermosensitive recording material of <1>, wherein the electron-accepting compound is one selected from the group consisting of a salicylic acid derivative and a polyvalent metal salt thereof.

<5> The thermosensitive recording material of <3>, wherein the electron-accepting compound is a combination of the compound represented by Formula (I) and one selected from the group consisting of a salicylic acid derivative and a polyvalent metal salt thereof.

<6> The thermosensitive recording material of <1>, wherein the thermosensitive recording layer includes the electron-accepting compound in a ratio of from 5/1 to 15/1 by mass ratio with respect to the electron-donating dye precursor.

<7> The thermosensitive recording material of <1>, wherein the thermosensitive recording layer includes the electron-accepting compound in a ratio of from 5/1 to 10/1 by mass ratio with respect to the electron-donating dye precursor.

<8> The thermosensitive recording material of <1>, wherein the support is one selected from a transparent support, synthetic paper or resin-coated paper.

<9> The thermosensitive recording material of <1>, which further includes a protective layer on the thermosensitive recording layer.

All publications, patent applications, and technical standards mentioned in this specification are herein incorporated by reference to the same extent as if each individual publication, patent application, or technical standard was specifically and individually indicated to be incorporated by reference.

What is claimed is:

1. A thermosensitive recording material comprising, on a support, a thermosensitive recording layer comprising an electron-donating dye precursor and an electron-accepting compound that makes the electron-donating dye precursor thermally develop a color, wherein the thermosensitive recording layer comprises the electron-accepting compound in a ratio of from 5/1 to 20/1 by mass ratio with respect to the electron-donating dye precursor.

2. The thermosensitive recording material of claim 1, wherein the electron-donating dye precursor is selected from fluoran or phthalide compounds.

3. The thermosensitive recording material of claim 1, wherein the electron-accepting compound comprises a compound represented by the following Formula (I): 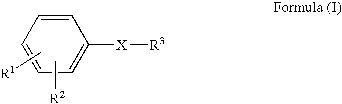
wherein R¹ and R² each independently represent a hydrogen atom, an alkyl group, an alkenyl group, a hydroxy group, a halogen atom or —SO₂Ar; R³ represents —Ar, —NH—Ar or —NH—CO—NH—Ar; Ar represents an aromatic ring; the aromatic ring may be substituted by at least one member selected from a hydroxy group, an alkyl group, an alkenyl group, an alkoxy group, a halogen atom or —SO₂Ar; and X represents a divalent linking group represented by any of the following: 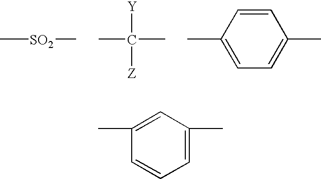
wherein Y and Z each independently represent a hydrogen atom or an alkyl group, and Y and Z may bond to each other to form a ring.

4. The thermosensitive recording material of claim 1, wherein the electron-accepting compound is one selected from the group consisting of a salicylic acid derivative and a polyvalent metal salt thereof.

5. The thermosensitive recording material of claim 3, wherein the electron-accepting compound is a combination of the compound represented by Formula (I) and one selected from the group consisting of a salicylic acid derivative and a polyvalent metal salt thereof.

6. The thermosensitive recording material of claim 1, wherein the thermosensitive recording layer comprises the electron-accepting compound in a ratio of from 5/1 to 15/1 by mass ratio with respect to the electron-donating dye precursor.

7. The thermosensitive recording material of claim 1, wherein the thermosensitive recording layer comprises the electron-accepting compound in a ratio of from 5/1 to 10/1 by mass ratio with respect to the electron-donating dye precursor.

8. The thermosensitive recording material of claim 1, wherein the support is one selected from a transparent support, synthetic paper or resin-coated paper.

9. The thermosensitive recording material of claim 1, which further comprises a protective layer on the thermosensitive recording layer.
